(19) United States
(12) Patent Application Publication
(10) Pub. No.: US 2012/0033339 A1
(43) Pub. Date: Feb. 9, 2012

(54) SURGE PROTECTION MAGAZINE FOR A DEVICE IN TELECOMMUNICATIONS AND DATA TECHNOLOGY

(75) Inventors: Adrian Benedetto, Berlin (DE); Johann Oltmanns, Berlin (DE)

(73) Assignee: ADC GmbH, Berlin (DE)

(21) Appl. No.: 13/147,066

(22) PCT Filed: Dec. 18, 2009
(86) PCT No.: PCT/EP09/09162

§ 371 Date: Oct. 14, 2011

(30) Foreign Application Priority Data
Feb. 4, 2009 (DE) 10 2009 007 338.8

(51) Int. Cl. H02H 1/04

(52) U.S. Cl. 361/119

(57) ABSTRACT

The invention relates to a surge protection magazine (1) for a device in telecommunications and data technology, comprising a housing (2), a printed circuit board (3), a plurality of surge arrestors (6) and at least one ground contact (4). The surge arrestors (6) are arranged on the printed circuit board and connected via conductor tracks to contact pads (10, 11) disposed on the printed circuit board (3). On the underside (20), the housing (2) has at least one opening for the at least one ground contact (4), wherein the part of the ground contact (4) that is pushed through the opening is designed as a single tuning fork contact (41, 42), and wherein the ground contact (4) has a second single tuning fork contact (42) which makes contact with the printed circuit board (3). The planes (E1, E2) of the two single tuning fork contacts (41, 42) are rotated 90° with respect to each other, and the ground contact (4) is formed in one piece.

The invention relates to an overvoltage protection magazine for a telecommunications and data technology device.

DE 103 17 621 A1 has disclosed a generic overvoltage protection magazine for a telecommunications and data technology device, comprising a housing, a printed circuit board, a plurality of surge arresters and at least one grounding contact, the surge arresters being arranged on the printed circuit board and being connected to contact pads arranged on the printed circuit board via conductor tracks, which contact pads, in the plugged state, come into electrical contact with contacts of the telecommunications and data technology device, the housing having slit-shaped openings on the lower side for the parts of the printed circuit board which bear the contact pads and having at least one opening for the at least one grounding contact, that part of the grounding contact which is plugged through the opening being in the form of a single fork contact. The other part of the grounding contact, which is used for making contact with a grounding cable on the printed circuit board, is in this case in the form of a double fork contact.

Furthermore, the slit-shaped opening for the grounding contact is arranged in such a way that it is offset with respect to the slit-shaped openings of the printed circuit board.

DE 197 08 802 C2 has disclosed an electrical circuit arrangement of a staggered protective circuit, comprising a three-pole surge arrester, two PTC thermistors and two diodes for safeguarding an a,b twin core.

The invention is based on the technical problem of providing a generic overvoltage protection magazine which has a simpler design and manufacture.

The solution to the technical problem results from the subject matter having the features of claim 1. The further advantageous configurations of the invention result from the dependent claims.

In this regard, the overvoltage protection magazine for a telecommunications and data technology device comprises a housing, a printed circuit board, a plurality of surge arresters and at least one grounding contact, the surge arresters being arranged on the printed circuit board and being connected to contact pads arranged on the printed circuit board via conductor tracks, which contact pads, in the plugged state, come into electrical contact with contacts of the telecommunications and data technology device, the housing having slit-shaped openings on the lower side for the parts of the printed circuit board which bear the contact pads and having at least one opening for the at least one grounding contact, that part of the grounding contact which is plugged through the opening being in the form of a single fork contact, the opening for the grounding contact being a slit-shaped opening for the printed circuit board or a separate slit-shaped opening, which is positioned on a line with the slit-shaped openings of the printed circuit board, the grounding contact having a second single fork contact, for making contact with the printed circuit board, the planes of the two single fork contacts being rotated through 90° with respect to one another, the grounding contact being formed in one piece. As a result, the printed circuit board is in one plane with the single fork contact, which is plugged through the housing lower side and is intended to produce the external connection to ground, for example by means of making contact with a limb of a mounting trough. Preferably, the overvoltage protection magazine in this case has two grounding contacts.

In a further preferred embodiment, at least one guide and one stop element for the grounding contact are arranged on the inner side of the lower side, with the slit-shaped opening running between said guide and stop element. This ensures that the grounding contact cannot slide through the slit-shaped opening. As a result of the guide, in this case the single fork contact is aligned with respect to the slit-shaped opening and at the same time is also guided in a defined manner with respect to the stop element. In embodiments with two grounding contacts, correspondingly two guides and two stop elements are provided, which are preferably arranged transposed with respect to the slit-shaped opening, with the result that only one design of the grounding contact is required.

In a further preferred embodiment, the guide is in the form of an elevation with a U-shaped cross section, the limbs of the elevation pointing towards the slit-shaped opening.

In a further preferred embodiment, the stop element is in the form of a square, which is flatter than the guide. In this case it is true that preferably the stop element is flatter than the guide, irrespective of its configuration.

In a further preferred embodiment, the overvoltage protection magazine has a cover, which is connected, preferably screwed, to the housing and fixes the printed circuit board in the housing.

The invention will be explained in more detail below with reference to a preferred exemplary embodiment, in which:

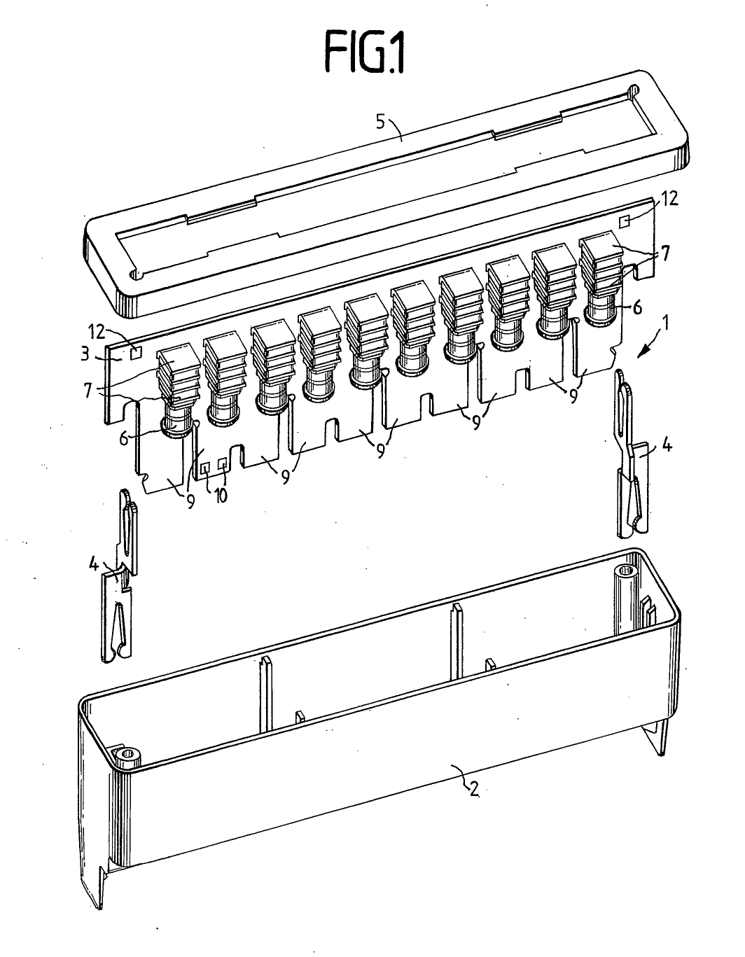

FIG. 1 shows an exploded illustration of an overvoltage protection magazine in a front view,

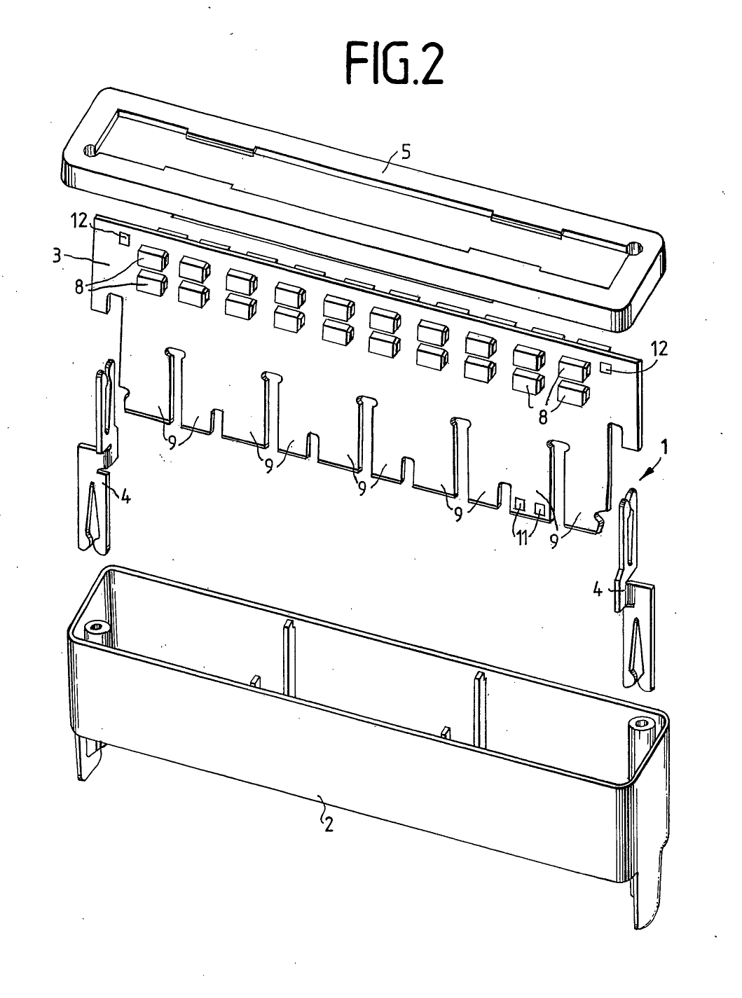

FIG. 2 shows an exploded illustration of the overvoltage protection magazine in a view from the rear,

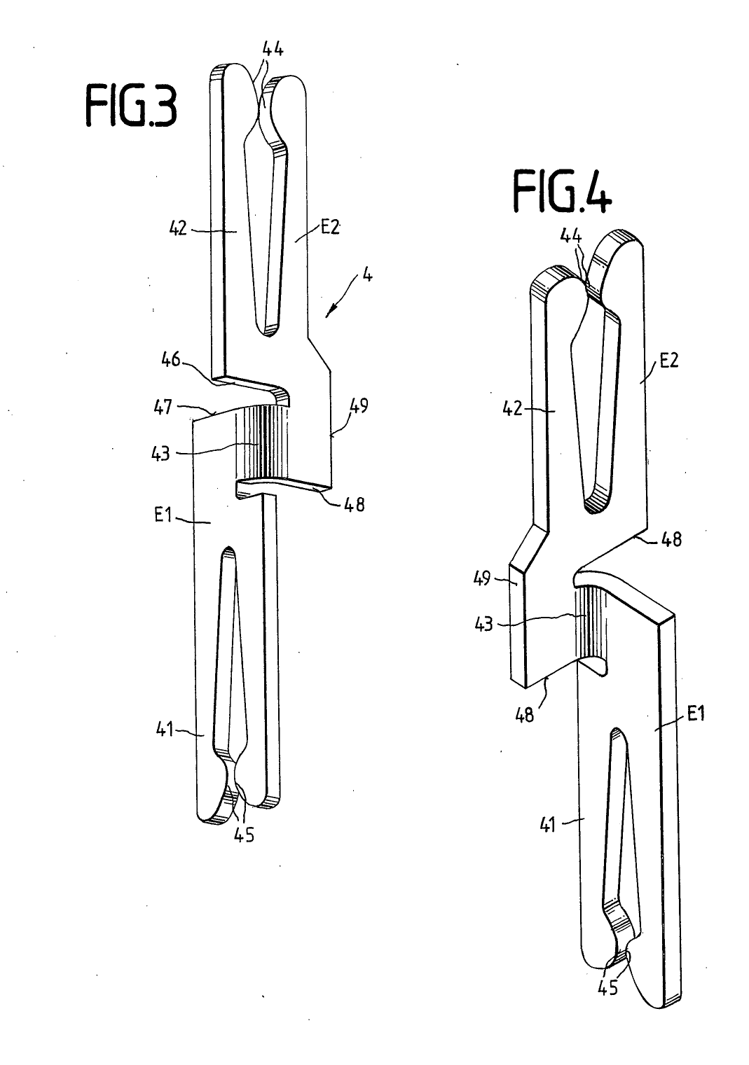

FIG. 3 shows a first perspective illustration of a grounding contact,

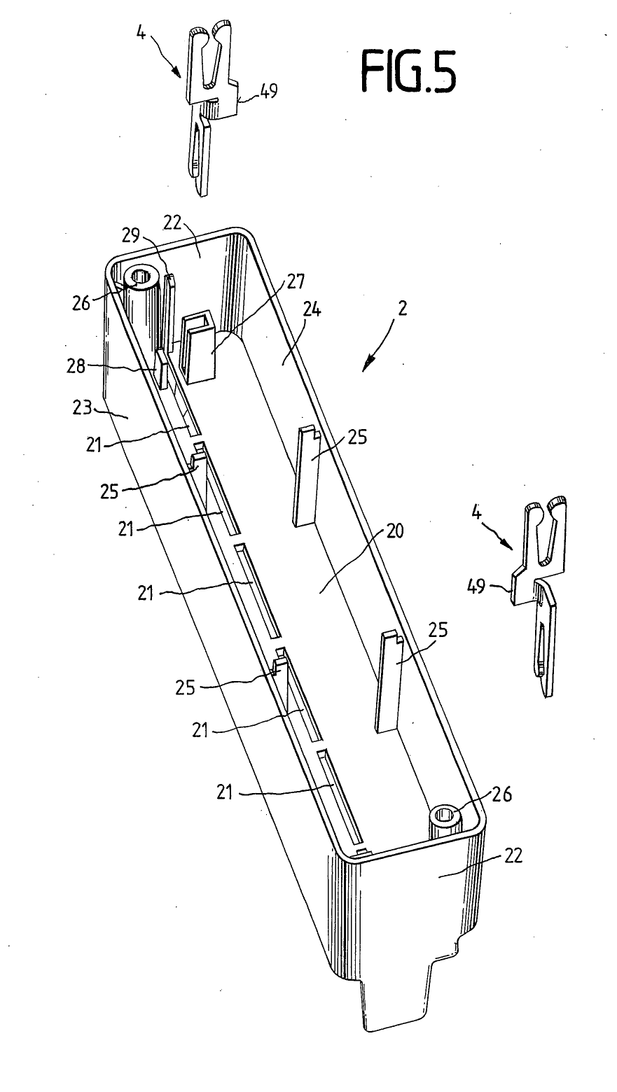

FIG. 4 shows a second perspective illustration of the grounding contact,

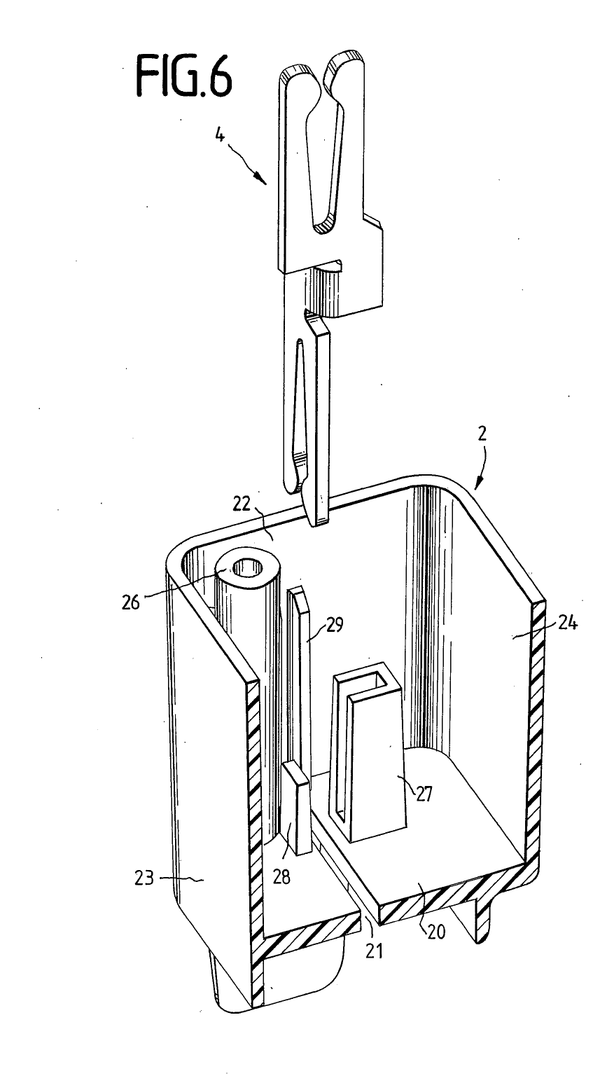

FIG. 5 shows a perspective illustration of the housing without the printed circuit board,

FIG. 6 shows a detail illustration of the housing,

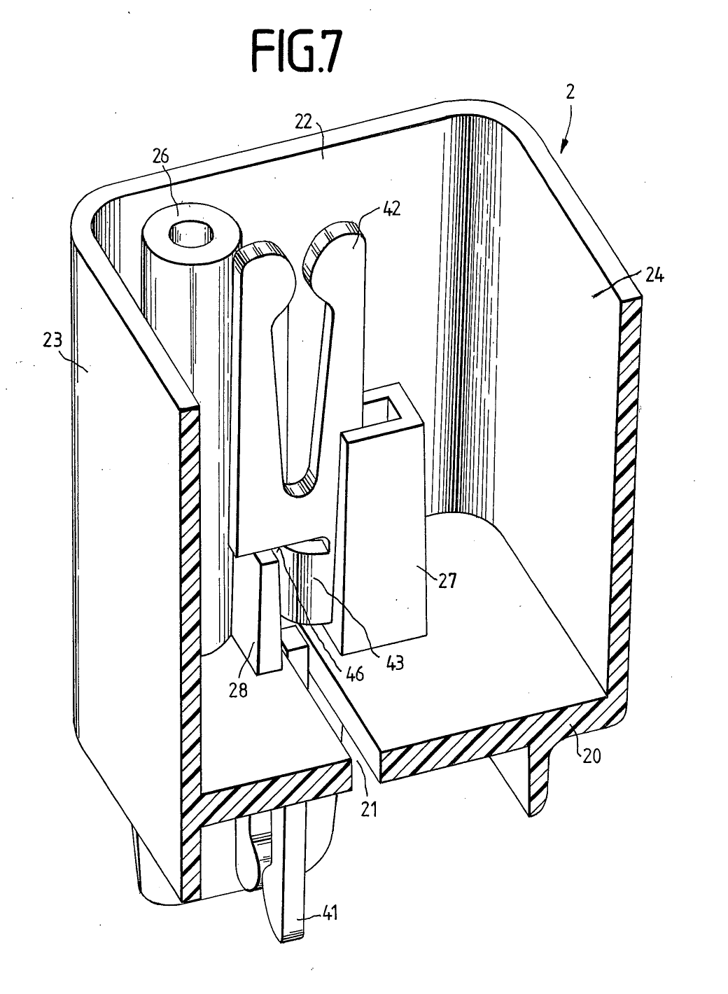

FIG. 7 shows a detail illustration of the housing with the grounding contact plugged in,

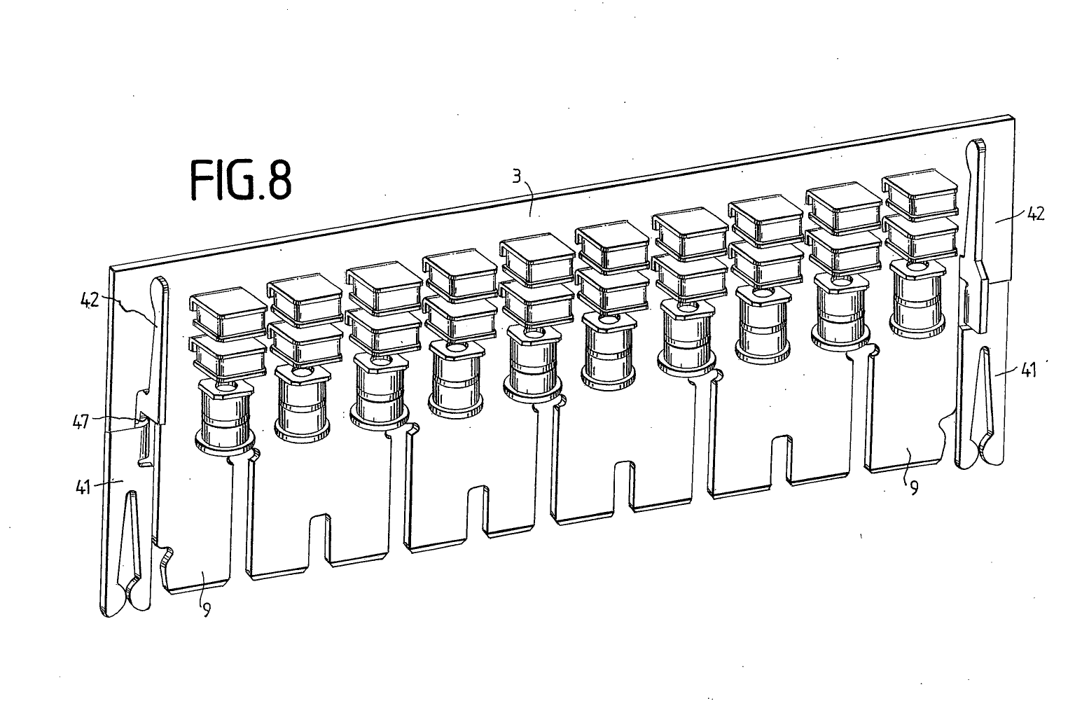

FIG. 8 shows a perspective illustration of the printed circuit board with grounding contacts, and

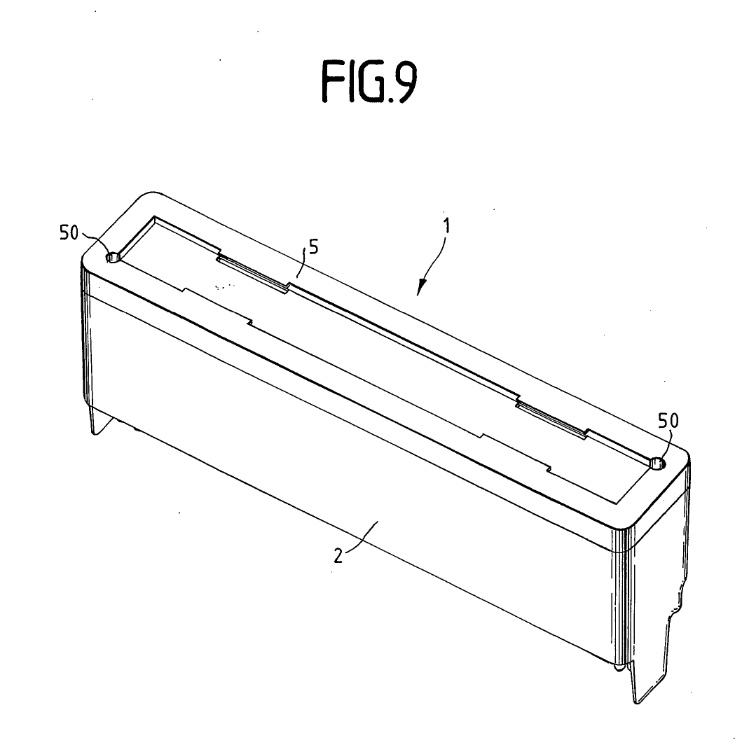

FIG. 9 shows a perspective illustration of the overvoltage protection magazine in the assembled state.

FIGS. 1 and 2 each illustrate an overvoltage protection magazine 1. The overvoltage protection magazine 1 comprises a housing 2, a populated printed circuit board 3, two grounding contacts 4 and a cover 5. Ten three-pole surge arresters 6 and twenty PTC thermistors 7 are arranged on the front side of the printed circuit board 3, and twenty diodes 8 are arranged on the rear side in order to realize a 10 twin-core overvoltage protection means. Reference is made to DE 197 08 802 C2 as regards the series connection of surge arresters 6, PTC thermistors 7 and diodes 8. Ten plug-in tongues 9 are cut out of the printed circuit board 3, with two contact pads 10 being arranged on each plug-in tongue 9 on the front side and two contact pads 11 on the rear side, in this case only the contact pads 10, 11 for a plug-in tongue 9 being illustrated. The contact pads 10, 11 of the front and rear side are in this case not through-plated. In embodiments without PTC thermistors 7 and diodes 8, the contact pads 10, 11 can be through-plated, on the other hand. Furthermore, the printed circuit board 3 has at least two contact pads 12 for the grounding contacts 4, which are connected to the grounding cables of the surge arresters 6. In this case, a respective contact pad 12 can also be arranged on the front and rear side of the printed circuit board 3 for each grounding contact 4, as is illustrated in FIGS. 1 and 2 as well, which contact pads 12 can also be through-plated.

First of all, the grounding contact 4 will be explained in more detail with reference to FIGS. 3 and 4. The grounding contact 4 comprises a first single fork contact 41 and a second single fork contact 42, which are connected to one another via a bent connecting web 43. In this case, the grounding contact 4 is preferably in the form of a stamped and bent part in one piece, the two single fork contacts 41, 42 being rotated through 90° with respect to one another, i.e. the plane E1 is perpendicular to the plane E2.

The electrical contact between the second single fork contact 42 and the contact pads of the printed circuit board 3 is made in this case in the contact region 44. The electrical contact between the first single fork contact 41 and electrically conductive parts of a mounting system, such as the limbs of a U-shaped trough, for example, is made in the contact region 45. The lower sides 46, 47 form stop edges, which will be explained in more detail further below. Furthermore, the protruding lower side 48 or the edge 49 of the connecting web 43 forms an insertion edge, which will likewise be explained in more detail further below.

FIG. 5 illustrates the housing 2 without the printed circuit board 3 and the cover 5. The lower side 20 of the housing 2 has six slit-shaped openings 21, with one slit-shaped opening 21 being hidden visually by an end side 22. Reinforcing ribs 25, which are at the same time used as a rest for the cover 5, are arranged on inner sides of the front and rear side 23, 24.

Furthermore, the housing 2 has two elevations 27, which are U-shaped in cross section, two stop elements 28 and two printed circuit board guides 29, the elevation 27, the stop element 28 and the printed circuit board guide 29 as well as the slit-shaped opening 21 being hidden by the front end side 22 on one side. The hidden elevation 27 and the stop element 28 are in this case transposed in terms of their arrangement in relation to the slit-shaped opening 21, i.e. the hidden elevation 27 is on that side of the slit-shaped opening 21 which faces the front side 23. Correspondingly, the grounding contact 4 is rotated through 180°. The slit-shaped opening 21, through which the grounding contact 4 and the respectively outermost plug-in tongue 9 of the printed circuit board 3 is intended to be plugged, runs between the elevation 27 and the stop element 28. In this case, the elevation 27 for guiding the grounding contact 4 is higher than the stop element 28.

FIG. 6 shows an enlarged illustration in particular of the elevation 27 and the stop element 28, and FIG. 7 illustrates the grounding contact 4 in the plugged-in position. In this case, the grounding contact 4 is first rotated in such a way that the single fork contact 41 is aligned with respect to the slit-shaped opening 21. The single fork contact 42 is aligned with respect to the elevation 27 and the lower edge 48 or edge 49 is plugged into the U-shaped guide of the elevation 27. If the grounding contact 4 then slides down, the single fork contact 41 slides through the slit-shaped opening 21 until the lower edge 46 hits the stop element 28 and thus prevents any further sliding.

FIG. 8 illustrates the populated printed circuit board 3 with the plugged-on grounding contacts 4, with the contact pads not being illustrated. The two single fork contacts 41 are in this case in the plane of the printed circuit board 3. In this case, the printed circuit board 3 presses on the lower side 47, which acts as a stop edge for the printed circuit board 3. During mounting, first the two grounding contacts 4 are plugged in and then the printed circuit board 3 is plugged in. In this case, the two single fork contacts 41 are each arranged offset with respect to the adjacent end side 22 in relation to an imaginary center line of their associated single fork contacts 42, in order thus to provide space for the two outer plug-in tongues 9 of the printed circuit board 3.

Finally, FIG. 9 illustrates the overvoltage protection magazine 1 in the assembled state, with the cover 5 being screwed on, and with the screws (not illustrated) being screwed through the openings 50 into the hollow cylinder 26.

### LIST OF REFERENCE SYMBOLS

1 Overvoltage protection magazine
2 Housing
3 Printed circuit board
4 Grounding contacts
5 Cover
6 Surge arrester
7 PTC thermistor
8 Diode
9 Plug-in tongue
10-12 Contact pads
20 Lower side
21 Slit-shaped opening
22 End side
23 Front side
24 Rear side
25 Reinforcing ribs
26 Hollow cylinder
27 U-shaped elevation
28 Stop elements
29 Printed circuit board guides
41, 42 Single fork contacts
43 Connecting web
44, 45 Contact regions
46-48 Lower sides
49 Edge
50 Openings

1. An overvoltage protection magazine for a telecommunications and data technology device, comprising a housing, a printed circuit board, a plurality of surge arresters and at least one grounding contact, the surge arresters being arranged on the printed circuit board and being connected to contact pads arranged on the printed circuit board via conductor tracks, which contact pads, in the plugged state, come into electrical contact with contacts of the telecommunications and data technology device, the housing having slit-shaped openings on the lower side for the parts of the populated printed circuit board which bear the contact pads and having at least one opening for the at least one grounding contact, that part of the grounding contact which is plugged through the opening being in the form of a single fork contact,
wherein
the opening for the grounding contact is a slit-shaped opening for the populated printed circuit board or a separate slit-shaped opening, which is positioned on a line with the slit-shaped openings of the printed circuit board, the grounding contact having a second single fork contact, which makes contact with the printed circuit board, the planes of the two single fork contacts being rotated through 90° with respect to one another, the grounding contact being formed in one piece.

2. The overvoltage protection magazine as claimed in claim 1, wherein the overvoltage protection magazine is formed with two grounding contacts.

3. The overvoltage protection magazine as claimed in claim 1 wherein at least one guide and one stop element for the grounding contact are arranged on the inner side of the lower side, with the slit-shaped opening running between said guide and stop element.

4. The overvoltage protection magazine as claimed in claim 3, wherein the guide is in the form of an elevation with a U-shaped cross section.

5. The overvoltage protection magazine as claimed in claim 3 wherein the stop element is in the form of a square, which is flatter than the guide.

6. The overvoltage protection magazine as claimed in claim 1, wherein the overvoltage protection magazine has a cover, which is connected to the housing.
